(19) United States
(12) Patent Application Publication
(10) Pub. No.: US 2015/0083839 A1
(43) Pub. Date: Mar. 26, 2015

(54) PRESS ROLL

(71) Applicant: MASCHINENFABRIK KÖPPERN GMBH & CO. KG, Hattingen (DE)

(72) Inventors: Eggert DE WELDIGE, Velbert-Langenberg (DE); Andreas PACKEINSEN, Gladbeck (DE); Alex HOEFTER, Meppen (DE)

(21) Appl. No.: 14/381,468

(22) PCT Filed: Mar. 6, 2013
(86) PCT No.: PCT/EP2013/054512

§ 371 Date: Aug. 27, 2014

(30) Foreign Application Priority Data
Mar. 15, 2012 (DE) 102012102199.6 15

(51) Int. Cl. B02C 4/30

(52) U.S. Cl. CPC B02C 4/305
USPC 241/227; 241/294

(57) ABSTRACT

The invention relates to a press roll (1) for a roll press, in particular for comminuting highly abrasive materials, comprising a roll body (2). Hard bodies as exchangeable edge protection elements (5) are removably fixed to one or both roll edges of the roll body (2). The edge protection elements (5) are completely or partly made of a metal matrix composite (MMC) material.

The invention relates to a crush roller for a roller press, in particular for comminuting highly abrasive materials, comprising a roller body carrying on the edge at one or both ends a plurality of protective hard inserts that are removably mounted so they can be replaced.

A roller press generally has two crush rollers. Roller presses are used particularly for the comminution, particularly high-pressure comminution, of coarse mineral material, such as ores, cement clinker, slag, kimberlite, coal or ceramic base materials. Roller presses of this type are also referred to as high compression roller mills. However, the invention also comprises roller presses for compacting or briquetting material.

In the processing and particularly the comminution of brittle, granular material using such a roller press, high forces are applied and the surfaces of the rollers are under great stress, so that protecting the roller surfaces against wear is generally of special importance. Thus it is known in practice to protect roller surfaces against wear by using cylindrical hard metal pins and/or studs that are embedded “hedgehog-like” in corresponding blind bores in the roller body, and together with the material to be crushed between the rollers, form an autogenous layer of wear protection (see EP 0 516 952 [U.S. Pat. No. 5,269,477]). However, this type of wear protection is generally unsatisfactory in the region of the roller ends due to the high risk of the pins breaking off at the edges. For this reason, measures specifically for protecting the edges and/or for wear protection at the edges of the roller have been proposed.

For example, EP 1 502 650 [U.S. Pat. No. 7,510,135] describes a crush roller with circumferential annular grooves on the roller end edges and each holding a row of wear-protection inserts. The wear-protection inserts thus form a quasi-closed ring that is intended to provide high wear protection. These wear-protection inserts are made of hard metal. They can be attached directly in the circumferential annular grooves by adhesive bonding, clamping, or soldering.

This also applies to EP 1 684 907 [U.S. Pat. No. 7,497,396] that describes a crush roller or grinding roller for pressure grinding granular material, on which multiple hard bodies are carried for edge protection on the roller end edges in a circumferential annular groove of the roller shell, these hard bodies projecting both axially from the end face and radially from the side surface of the roller shell. The hard bodies are made particularly of sintered hard metal.

An alternative wear protection concept is described in EP 0 659 108 [U.S. Pat. No. 5,755,033]. The wear layer of the crush roller essentially has planar zones made of a highly wear-resistant material that can be formed, for example from ceramic tiles and/or glazed tiles. The interstices between the highly wear-resistant zones are filled with a material of different wear resistance. The ceramic tiles and/or glazed tiles can be produced, for example from a metal-matrix composite material by hot isostatic pressing. These prefabricated hard bodies are then permanently mounted, together with the interstice material, onto the base body by hot isostatic pressing.

In connection with the above-described wear protection concept with studs, EP 0 578 239 proposes that the recesses in the roller body receiving the pin-shaped studs have outwardly curved surfaces in their deepest regions, and the lower portions of the embedded material pieces are shaped to fit complementarily in the bottoms of the recesses. As a result, the acting high pressure force is supposed to be transmitted evenly to the material of the roller body. In addition, this document proposes to make the embedded material pieces so as to be two parts, at least one insert made of a further material being set in each of the recesses of the roller body underneath the embedded pin-shaped material pieces, this insert corresponding in its shape to that of the recesses in their deepest regions. Such proposals had no influence on the existing edge protection concepts.

This also applies while taking into consideration EP 0 699 479 [U.S. Pat. No. 5,704,561], which proceeds from the known wear concepts with studs and proposes that each stud be composed of a radially inner bolt part easily weldable to the roller surface, and a radially outer harder bolt part protectively covering the inner pin part. The outer bolt part consists of hard materials and is bonded to the radially inner bolt part. The radially outer bolt part can consist of hard metal and/or ceramic material and/or hard welding materials.

Proceeding from the above-described prior art, the object of the present invention is to create a crush roller for a roller press that is particularly wear resistant and yet has replaceable wear protection on the roller end edges.

For a generic crush roller of the above-described type, this problem is solved in that the edge protectors (detachably) fastened to the roller body are entirely or partially made of a metal-matrix composite material (MMC).

Metal-matrix composite material refers to a material in which hard particles are integrated in a (cohesive) metallic matrix, the hard particles being preferably arranged within the composite material, separated from one another by the (cohesive) metallic matrix. Such edge protectors made of a metal-matrix composite material are preferably produced by sintering and/or hot-isostatic pressing. At first, the powdered components for the hard particles and the metal matrix are mixed and subsequently heated, in case of hot-isostatic pressing, at high pressure. The powdered components thus bond with one another at high temperatures and, in case of hot-isostatic pressing, at high pressure. In the finished material produced by sintering and/or hot-isostatic pressing, the nonmetallic hard particles are evenly distributed and each surrounded by the metallic material of the metal matrix.

Metal-matrix composite materials thus differ from hard metals, among others, because of their relatively low percentage of hard particles. While for hard metals, hard materials with a percent by volume of approximately 80% to 96% are mixed with a metallic binding agent as durability component, metal-matrix composite materials are characterized by a distinctly lower percentage of hard particles, and so they are embedded separate from one another in a continuous metal matrix. The hard particles of the metal-matrix composite materials are also distinctly larger than the hard particles of hard metals. Within the scope of the invention, a metal-matrix composite material is preferably used for which hard particles with a size of more than 20 μm, for example more than 40 μm, preferably more than 60 μm, but no larger than 1000 μm and with a percent by volume of less than 50%, preferably less than 40%, are used that are (discontinuously) embedded in a (continuous) metallic matrix. This refers to percentages by volume in the (pressed) hard body.

Preferably, metal-matrix composite materials with hard particles from the group of carbides and borides are used. Alternatively, metal-matrix composite materials with hard particles from the group of nitrides and oxides can also be used. Furthermore, it is basically within the scope of the invention to use metal-matrix composite materials for the edge protectors with hard particles made of hard metal. In other words, in these metal-matrix composite materials, hard particles made of hard metal of the dimension described above with the above-mentioned percent by volume are embedded in a metallic matrix. However, these are explicitly not edge protectors made of hard metal but edge protectors made of a metal-matrix composite material, where only the hard particles and thus only the reinforcement phase is made of hard metal.

The invention proceeds from the rationale that excellent wear protection can be realized on the end edges of the roller if the edge protectors are made entirely or also partially from such a metal-matrix composite material. Such a metal-matrix composite material, with a suitable choice of material, is less brittle than hard metal and less sensitive to bending. Furthermore, the fact that the wear of the metal-matrix composite materials is “adjustable” within certain limits, and so metal-matrix composite materials can be used with a wear that is set in a suitable manner to the (remaining) roller surface, is of particular importance. This is advantageous because the rollers maintain their (cylindrical) form during operation. The problem during operation is that of the pressure usually being lower at the edge of the rollers than in the center of the roller. The problem with the use of edge protectors made of hard metal is basically their slower wear on the edge (due to lower pressure). Therefore, the roller diameter decreases in the center of the roller as opposed to the diameter on the roller ends, resulting in a roller with a quasi-“concave” geometry. In extreme cases, this results in the material in the center of the roller not being sufficiently crushed. These problems can be prevented with the use of edge protectors made of a metal-matrix composite material.

The edge protectors made of MMC according to the invention can basically be used on roller bodies havig pockets or annular grooves that extend in the known manner angularly on one or both roller end edges with a plurality of edge protectors inserted in each of the recesses or annular grooves. Alternatively, the edge protectors can also be attached on the end faces of the base body.

However, the edge protectors made of MMC according to the invention are preferably used in an embodiment in which the roller body has multiple pockets on one or both roller end edges that are distributed around the circumference and spaced apart angularly or tangentially, each being designed so as to be open axially and radially outward, wherein only one MMC hard body as replaceable edge protector is inserted in each of the individual pockets. Preferably, the length of the pockets and the length of the inserted edge protectors angularly is greater than the spacing between two directly adjacent recesses.

Such an embodiment with locally delimited seat pockets is advantageous over the solutions with circumferential annular grooves because the individual edge protectors do not come in contact with one another despite the very high pressing forces and thus cannot collide or be pressed against one another. As a result, damage to the individual edge protectors is prevented, particularly damage through breakage that could basically occur with brittle hard materials. The arrangement of the edge protectors in individual, locally delimited pockets being further advantageous because the edge protectors are not only supported on a step-like shoulder on the underside and inside but also laterally. The design of the roller end edge with individual, locally delimited pockets results in the delimitation of the individual recesses from one another by “separating ridges,” and so the edge protectors are tangentially supported by such separating ridges. The high compression forces can be dissipated satisfactorily into the base body. Last, the embodiment with locally delimited pockets is advantageous because an autogenous wear protection, which particularly protects the edges of the inserted wear-protection inserts, can form in the region of the separating ridges and thus in the region between the individual pockets and edge protectors. Therefore, an autogenous wear protection can build up not only in the remaining roller regions but also in the end edge and between the individual edge protectors. As a result, scouring wear in these zones can be prevented.

In principle, the invention comprises—as already described—alternatively also the use of edge protectors made of MMC in circumferential annular grooves or the like.

Geometrically, the edge protectors can have highly diverse forms. Preferably, edge protectors are used that as seen radially on the roller surface, are designed so as to be polygonal, for example rectangular. It is within the scope of the invention that the edge protectors in side view of the roller are also designed so as to be polygonal, for example rectangular, and therefore the edge protectors can have the form, for example of a cube.

Particularly in conjunction with the locally delimited receiving pockets, edge protectors are preferably used whose shape deviates from that of a cube. For example, at least sections of the pockets can, in a side view, have curved floor surfaces and at least sections of the edge protectors can have a curved outer edge face complementary to the curved wall region. For example, (at least sections of) the curved floor surface of the recess and (at least sections of) the curved outer edge face can be designed so as to have a profile shaped as a circular arc or alternatively have a parabolic or hyperbolic shape. The previously described lateral or tangential support of the edge protectors and thus the dissipation of the compression forces into the base body can be thus optimized. Moreover, such pockets with curved wall regions are particularly easily cut in the base body, for example by milling.

According to the invention, the edge protectors are entirely or in sections made of a metal-matrix composite material (MMC). Within the framework of a first alternative, the edge protectors can be designed as substantially homogenous solid bodies, i.e. they are thus made entirely of MMC.

In an alternative second embodiment, the edge protectors can have a composite structure and, for that purpose, have a support element with a wear layer arranged on this support element, the support element consisting of a ductile material with less hardness than the wear layer. The wear layer itself is made of MMC. Such an embodiment is advantageous because the support element can be produced from an easy-to-process material, for example steel, that allows for a particularly optimal attachment of the edge protector on the roller body. The wear layer made of MMC thus forms the wear protection. In the course of producing the edge protectors, this wear layer can preferably be connected firmly to the support element, for example by sintering and/or hot-isostatic pressing (HIP).

The wear layer can completely cover the support element on the radial outer side. However, alternatively, the wear layer can be applied to the support element in a merely locally delimited manner, or for example set into a corresponding recess of the support element.

According to the invention, the edge protectors are detachably fastened on the roller body, and so the edge protectors are basically replaceable. Such an attachment can for example be achieved with a screw fastener. The edge protectors have appropriate holes, for example bores, for anchoring fasteners, for example screws, in the roller body. Such an embodiment is taken into consideration particularly when the edge protector has a support element made of a ductile material, for example steel. Alternatively, it is also within the scope of the invention to attach the edge protectors in the pockets by adhesive bonding or soldering (detachable). Alternatively or additionally, an interlocking connection of the edge protectors in the pockets can also be realized, for example by a “dovetail joint.” The edge protectors can be provided with (dovetail-type) form-lock ridges that mesh with corresponding negative forms, for example radial grooves of the roller.

Moreover, the crush roller can be designed as a solid roller, i.e. the roller body is designed as solid body. Alternatively, the roller body can also have a base body and a jacket surrounding it, and so the wear protection is subsequently mounted on/to this jacket.

In order to further optimize the fastening of the edge protectors in laterally open circumferential annular grooves or particularly also in locally delimited pockets and the transmission of the pressing forces into the roller body, edge protectors can be used that have a profile with at least sections of increasing radial dimension toward the center of the roller. Preferably, recesses are provided that also have a profile, at least sections of which are widening toward the center of the roller.

As already described, the edge protectors according to the invention are detachably fastened to the roller body. Within the scope of the invention, detachably indicates that they can be nondestructively removed for replacement purposes from the roller body, for example from the recesses. This also comprises connections that are adhesively bonded or soldered since they can be detached, for example through heating.

Subject matter of the invention is not only the described crush roller itself but, in a preferred development, also a roller press with two such crush rollers.

In the following, the invention will be described in greater detail with reference to a drawing that illustrates embodiments. In the drawing:

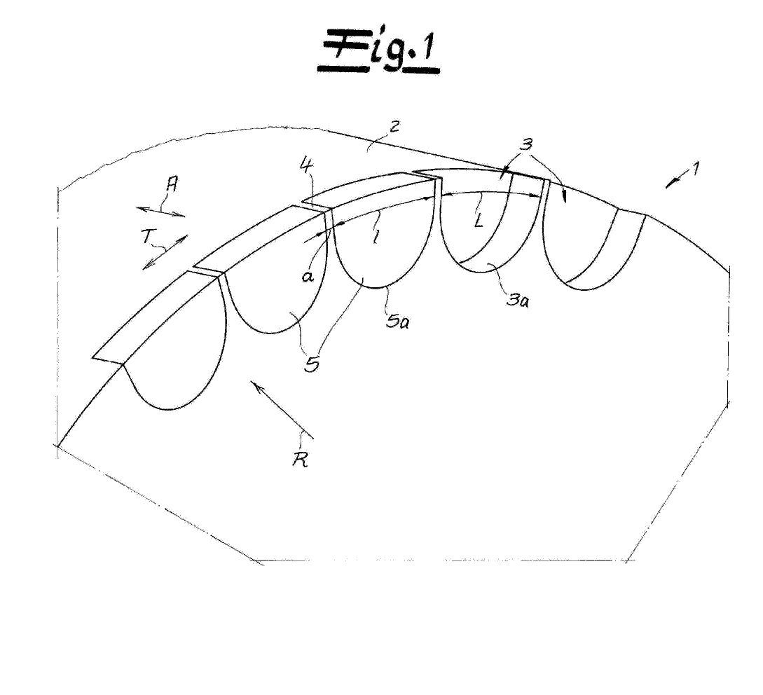

FIG. 1 is a perspective view of a detail of crush roller according to the invention in a first embodiment,

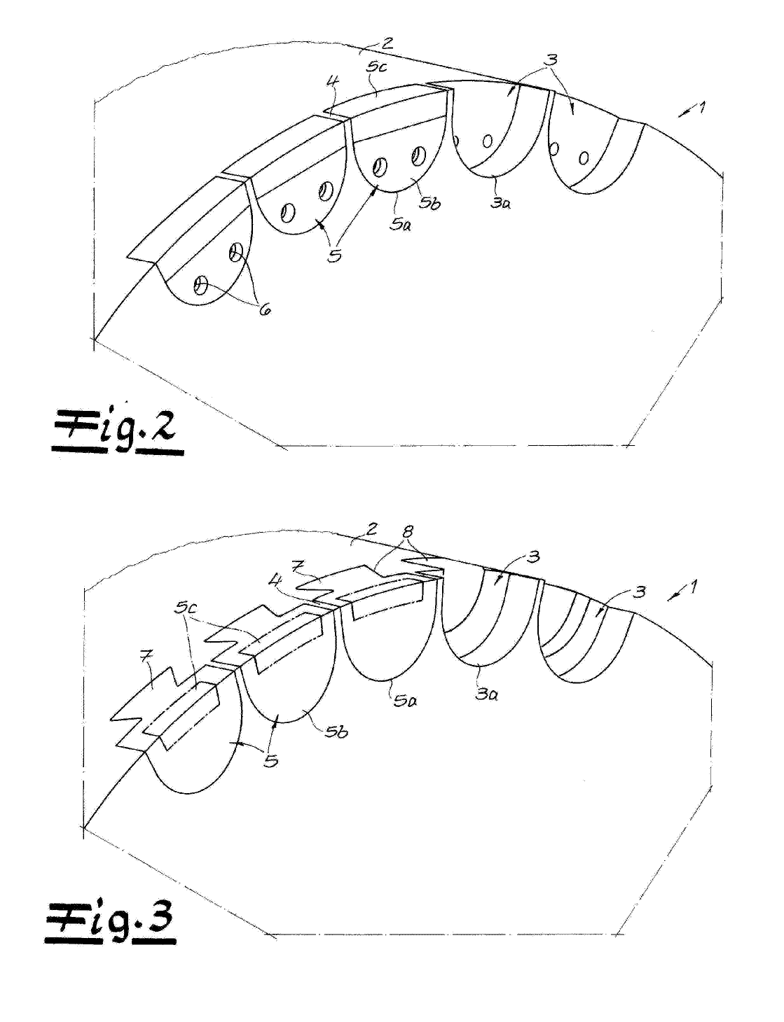

FIG. 2 shows the crush roller of FIG. 1 in a modified second embodiment,

FIG. 3 shows the crush roller of FIG. 1 in a modified third embodiment, and

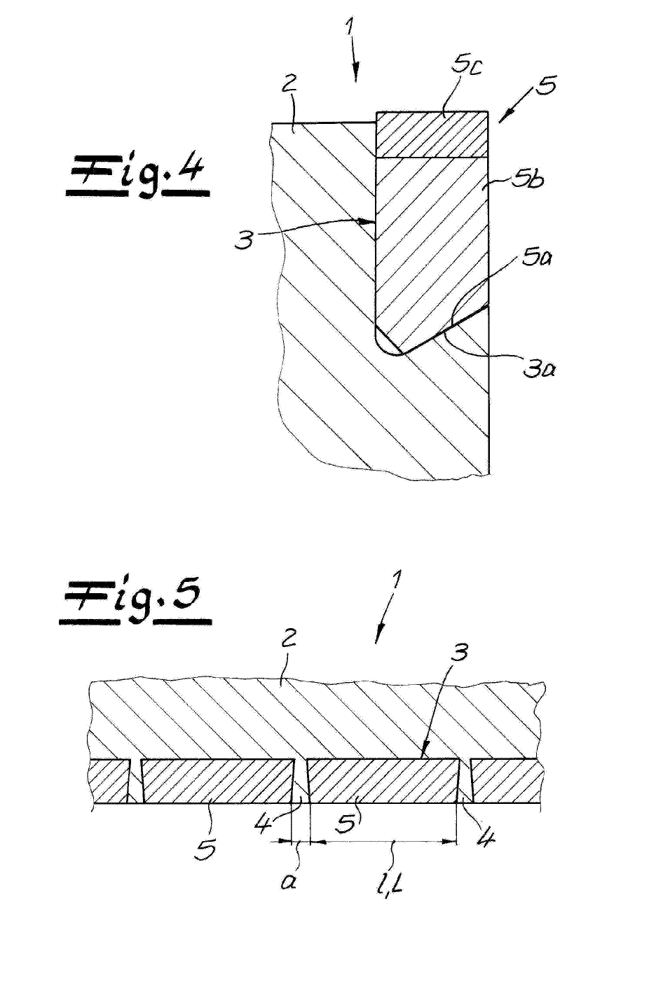

FIG. 4 is a cross-section of a modified embodiment of the invention,

FIG. 5 a further option of the invention.

Each of the figures shows a crush roller 1 for a roller crusher, in particular for the high-pressure comminution of brittle, mineral feed material. The roller crusher generally consists of two crush rollers 1, only a part of one of which is shown in the drawing. Such a crush roller 1 can—as shown in the drawing—be a solid roller, in which case the roller body 2 is designed as a solid body. Alternatively, however, the roller body can also have a base body and a jacket surrounding the base body. This option is not shown in the drawing.

In any case, such a crush roller is equipped with suitable wear protection that can be of various designs. The illustrations in the drawing are limited to wear protection measures in the region of the (end face) roller ends.

According to the invention, multiple hard bodies as replaceable edge protectors 5 are detachably fastened for edge protection to one or both roller end edges of the roller body 2. According to the invention, these edge protectors 5 are entirely or in sections made of a metal-matrix composite material (MMC).

The drawings show embodiments in which the roller body 2 has multiple pockets 3 on one or both roller end edges distributed and spaced in an angular or tangential direction T. The individual pockets 3 are separated from one another in the angular direction T by separating ridges 4. Each of the pockets 3 is designed so as to be open radially and axially. One single hard body as replaceable edge protector 5 is fitted to each of the individual pockets 3. The drawings show the crush roller 1 in a partially assembled state, i.e. for clarity of view some pockets 3 are shown without an inserted edge protector. FIG. 1 shows the angular or tangential direction T, axial direction A, and radial direction R. In the described embodiment, each of the recesses is open radially and axially outwardly. Within the scope of the invention, open axially means that the recess is open in the region of the end face of the roller, i.e. open on the face directed away in axial direction A from the center of the roller. Within the scope of the invention, open radially indicates that the recess is open to face away in the radial direction R from the roller axis. The lengths L, I, and the spacing a relate to the tangential direction T of the roller, i.e. in the region of the outer, upper edges of the edge protectors.

In the shown embodiments, the known circumferential annular grooves on the roller end edges are foregone. Instead, individual pockets and thus receiving pockets 3 are used, into each of which only one single edge protector 5 is inserted. According to the invention, the length L of the pockets and also the length I of the inserted edge protectors 5 is greater than the spacing a between two directly adjacent pockets 3. The lengths L, I and the spacing a relate to the circumferential direction T of the roller. The spacing a between the individual pockets 3 thus corresponds to the thickness of the ridges 4 arranged between the pockets 3 and thus also between the edge protectors 5, these ridges 4 being part of the roller body 2. The pockets 3 are formed in the roller body 2, for example by machining.

The shown embodiments with the individual pockets 3 are advantageous because the individual edge protectors 5, which are designed as hard bodies made of MMC, cannot touch and, despite of the high forces of the crushing operation, cannot be pushed into one another, so that damage to the edge protectors is prevented. Furthermore, this design allows for a perfect transmission of the occurring compression forces into the roller body 2. This applies particularly for the embodiment shown in the drawings, in which the pockets 3 have curved floor surfaces 3a in a side view and the edge protectors 5 have curved outer edges 5a, wherein the curved outer edge 5a being complementary to the curved floor surface 3a. In the embodiment according to FIGS. 1 to 3, the curved floor surfaces 3a and the curved outer edge surfaces 5a are each designed so as to be at least partially cylindrical.

FIG. 1 shows a first embodiment of the invention, in which the edge protectors 5 are made homogeneously from one and the same material, i.e. MMC. In the embodiment shown in FIG. 1, the edge protectors or hard bodies 5 made of MMC are attached in the recesses without screws, for example by adhesive bonding or soldering.

In an alternative embodiment, FIG. 2 shows edge protectors 5 that, as composite structure, each have a support element 5b and a wear layer 5c made of MMC that is on top of the respective support element 5b. The support element 5b consists of a ductile material, for example steel. Thus, the support element 5b is primarily used for attaching the edge protectors 5 in the recess 3, while the wear layer 5c determines the edge protection properties or wear properties. For such purpose, the wear layer 5c is made of a metal-matrix composite material. It is advantageous to fasten the wear layer 5c made of MMC to the support element 5b by sintering and/or hot-isostatic pressing. During manufacture, the individual edge protectors 5 with their support elements 5b and wear layers 5c are thus prefabricated and subsequently mounted in the pockets 3. FIG. 2 shows an embodiment where the edge protectors 5 are fastened to the roller body 2 by screws. The edge protectors 5 thus have suitable holes 6 or bores for the screws anchored the roller body 2. In the embodiment of FIG. 2, these bores 6 for the screws are in the support element 5 and thus in the ductile material.

FIG. 3 shows an alternative embodiment in which the edge protectors 5 are attached to the roller body 2 in a form-fitting manner, specifically by a dovetail. For this purpose, each of the edge protectors 5 has a mounting land 7, and in the region of each of the individual pockets 3, a groove 8 extending in the radial direction is arranged in the roller body 2, both the mounting lands and the grooves 8 being of complementary dovetail shape. Despite this form-fitting connection, it can be advantageous to also fasten the edge protectors 5 in the pockets 3 by gluing or soldering.

FIG. 3 optionally illustrates that these elements 5 can also be a composite component having a wear layer 5c and a support element 5b, the wear layer 5c being formed by a wear insert 5c that is fitted into a complementary recess of the support element 5b.

The edge protectors 5 shown in the drawing are rectangular on the roller as viewed radially. From an axial end view of the end face of the roller, however, the edge protectors 5 in the embodiment—as described—are rounded in some areas. In principle, the invention also comprises embodiments in which the edge protectors are designed as polygonal, for example rectangular, from an axial end view of the end face, so that edge protectors in the form of a rectangular prism, for example can also be achieved. This is not shown in the drawing.

It is also within the scope of the invention to alternatively or additionally provide the radial outer sides of the edge protectors with a curved shape, resulting, in particular, in an adaptation to the radius of curvature of the roller. This option is not illustrated.

Moreover, FIGS. 4 and 5 show very simplified and schematically modified embodiments in which the pockets 3 and the edge protectors 5 each have a shape with a radial depth increasing toward the center of the roller. By way of example, FIG. 4 shows an embodiment in which the lower floor surface 3a of the recess and the corresponding outer edge face 5a of the edge protectors in an axial section slope down from the roller end edge toward the center of the roller, thus forming an angled lower edge. The effect is such that the edge protectors 4 are securely pressed into the recess 3 by the forces occurring during pressing. Such an embodiment can be realized for edge protectors in highly diverse forms, for example also for the edge protectors shown in FIGS. 1 to 3. Optionally, FIG. 5 shows that alternatively or additionally, the pockets 3 and the edge protectors 5 can have a profile that “laterally” widens toward the center of the roller. The measures according to FIGS. 4 and 5 can also be combined with one another.

In the foreground of the invention is the design of the edge protectors 5 made of metal-matrix composite material (MMC).

By way of example, this is illustrated in the drawings with embodiments in which the edge protectors are inserted in locally delimited pockets 3. The invention also comprises embodiments, in which the edge protectors made of MMC are inserted in circumferential annular groove wherein, for example, one (entirely) circumferential recess each is provided on both roller end edges extending angularly into which the edge protectors are inserted. In a further alternative, the edge protectors made of MMC can also be attached on the side of the end faces of the roller body. These embodiments are not shown in the drawings.

1. A crush roller for a roller press, particularly for crushing highly abrasive materials, comprising a roller body in which hard bodies as replaceable edge protectors are fastened to one or both roller end edges of the roller body, wherein
the edge protectors are entirely or partially made of a metal-matrix composite material.

2. The crush roller according to claim 1, wherein the roller body, on one or both roller end edges, has multiple pockets distributed around the circumference and spaced apart in angular or tangential direction each being designed so as to be open axially and radially outward, only one hard body as replaceable edge protector being fitted in each of the individual pockets.

3. The crush roller according to claim 1, wherein the roller body, on one or both roller end edges, has one or more recesses that extend angularly and into each of which a plurality of the edge protectors is inserted.

4. The crush roller according to claim 1, wherein the edge protectors are attached on the end faces of the roller body.

5. The crush roller according to claim 1, wherein the edge protectors are made of a metal-matrix composite material by sintering or hot-isostatic pressing.

6. The crush roller according to claim 1, wherein the metal-matrix composite material contains hard particles with a size of more than 20 μm and with a percent by volume of less than 50% that are embedded separate from one another in a continuous metallic matrix.

7. The crush roller according to claim 1, wherein a metal-matrix composite material with hard particles from the group of carbides and borides is used.

8. The crush roller according to claim 1, wherein a metal-matrix composite material with a metallic matrix based on steel or on nickel is used.

9. The crush roller according to claim 1, wherein the edge protectors each have a support element and a wear layer on the support element, the support element consisting of a ductile material with less hardness than the wear layer of the metal-matrix composite material.

10. The crush roller according to claim 9, wherein the support elements consist of steel.

11. The crush roller according to claim 9, wherein the wear layer made of the metal-matrix composite material is attached on the support element by sintering or hot-isostatic pressing.

12. The crush roller according to claim 1, wherein the edge protectors are detachably fastened to the roller body by screw fasteners, adhesive bonding, or soldering.

13. The crush roller according to claim 1, wherein the edge protectors are detachably fastened on the roller body by an interlocking connection.

14. A roller press with two crush rollers according to claim 1.
